(19) United States
(12) Patent Application Publication
(10) Pub. No.: US 2012/0046924 A1
(43) Pub. Date: Feb. 23, 2012

(54) ION IMPLANTING SIMULATING METHOD AND A COMPUTER-READABLE MEDIUM

(75) Inventors: Sanae Ito, Yokohama-shi (JP); Takahisa Kanemura, Yokohama-shi (JP)

(73) Assignee: KABUSHIKI KAISHA TOSHIBA, Tokyo (JP)

(21) Appl. No.: 13/190,776

(22) Filed: Jul. 26, 2011

(30) Foreign Application Priority Data
Aug. 19, 2010 (JP) 2010-184136

(51) Int. Cl. G06F 17/50

(52) U.S. Cl. 703/2

(57) ABSTRACT

In one embodiment, there is provided an ion implanting simulating method of implanting incident particles into a substrate, and gaining stationary position coordinates of each of the incident particles in the substrate, thereby calculating the distribution of the incident particles in the substrate. In the method, the followings are repeated desired times by a computer: implanting one of the incident particles into the substrate; calculating the trace of the incident particle traveling in the substrate while undergoing collision with an atom contained in the substrate repeatedly, and the energy lost from the incident particle by the collision, based on a beforehand-inputted composition of the substrate, thereby calculating stationary position coordinates of the incident particle; and renewing the composition of the substrate in accordance with a matter that the substrate contains the implanted incident particle.

### CROSS REFERENCE TO RELATED APPLICATION

This application is based upon and claims the benefit of priority from prior Japanese Patent Application No. 2010-184136, filed on Aug. 19, 2010, the entire contents of which are incorporated herein by reference.

### FIELD

Embodiments of the present invention relate to an ion implanting simulating method and a computer-readable medium.

### BACKGROUND

The semiconductor process simulating method is a method of modeling a semiconductor element producing step that may be of various types to make a calculation, thereby gaining the structure of a semiconductor element to be formed, the distribution of an impurity in the semiconductor element, or some other. For example, it can be gained what state an impurity in a semiconductor element is distributed into by solving numerically a differential equation obtained by modeling an impurity-diffusing phenomenon, or some other phenomenon.

One of such semiconductor process simulating methods is a calculating method called the Monte Carlo method or particle method. The Monte Carlo method is a method of using random numbers to simulate a physical phenomenon faithfully, and is a method of using an expression obtained by modeling a physical phenomenon to trace the movements of individual particles.

### BRIEF DESCRIPTION OF THE DRAWINGS

FIG. 1 is a view illustrating a functional structure of a simulating device according to the embodiments;

FIG. 2 is a flowchart showing an example of the ion implanting simulating method according to the embodiments (part 1);

FIG. 3 is a flowchart showing the example of the ion implanting simulating method according to the embodiments (part 2);

FIG. 4 is a flowchart showing an ion implanting simulating method according to the first embodiment; and

FIG. 5 is a flowchart showing an ion implanting simulating method according to the second embodiment.

### DETAILED DESCRIPTION

In one embodiment, there is provided an ion implanting simulating method of implanting incident particles into a substrate, and gaining stationary position coordinates of each of the incident particles in the substrate, thereby calculating the distribution of the incident particles in the substrate. In the method, the followings are repeated desired times by a computer: implanting one of the incident particles into the substrate; calculating the trace of the incident particle traveling in the substrate while undergoing collision with an atom contained in the substrate repeatedly, and the energy lost from the incident particle by the collision, based on a beforehand-inputted composition of the substrate, thereby calculating stationary position coordinates of the incident particle; and renewing the composition of the substrate in accordance with a matter that the substrate contains the implanted incident particle.

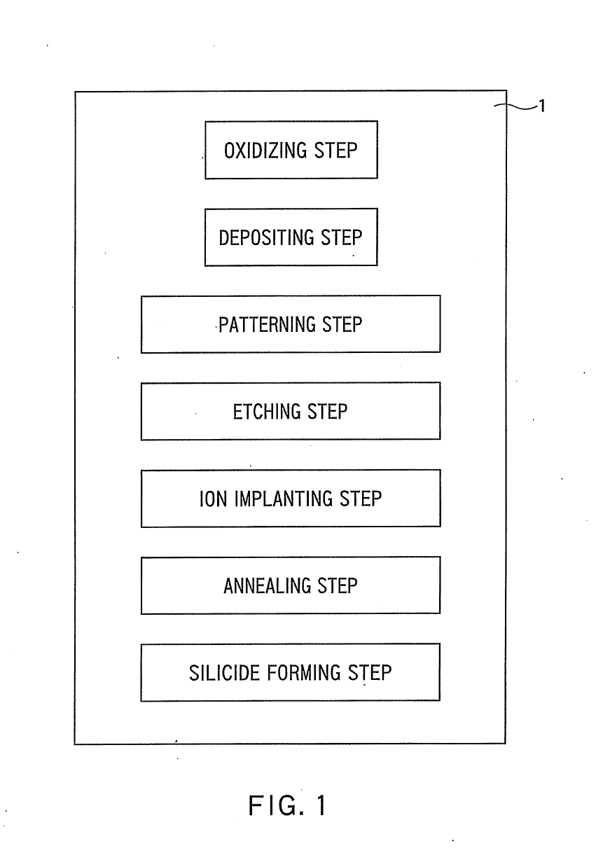

Hereafter, embodiments of the present invention will be described with reference to FIGS. 1 to 5. However, the invention is not limited to the embodiments.

Herein, a description is made about an example of a process simulating method about a process for producing a semiconductor element. However, the invention is not limited to such a process simulating method about a process for producing a semiconductor element. The invention may be applied to, for example, a process simulating method about a process for producing a material. The description made herein is about a process simulating method for simulating an ion implanting step, which is one step in a semiconductor element producing process. However, the invention is not limited thereto.

Before describing the embodiments of the present invention, a problem with conventional process simulating method will be described below.

A method for making a calculation about an ion implanting step by a process simulating method is the Monte Carlo method, which may be called the particle method. About the Monte Carlo method, first, a brief description will be made.

When a calculation is made by the Monte Carlo method, an atom that is to collide with a single incident particle (for example, an ion) is sought out.

When a simulating method is conducted about a case of implanting an incident particle into a material having an amorphous structure, for example, a material made of silicon dioxide (SiO₂), the following operation is made: an operation of calculating the free movement path of the ion from the number density of silicon (Si) atoms and oxygen (O) atoms that constitute the silicon dioxide material, seeking out probabilistically an atom which is to a partner in collision with the ion from the silicon (Si) atoms and the oxygen (O) atoms by an optional use of random numbers, and then specifying the kind of the atom and position coordinates thereof.

When a simulating method is performed about, for example, a case of implanting an incident particle into a silicon substrate having a crystal structure in which silicon (Si) atoms are regularly arranged, a silicon (Si) atom which is to collide with the incident particle is sought out from the entire Si atoms, considering also the positional displacement of the silicon (Si) atoms that is based on lattice vibration at a finite temperature. The position coordinates of the colliding silicon (Si) atom are then gained. Calculations are then made about situations of the collision of the incident particle with the silicon (Si) atom (such as the kinetic energy and the traveling or advancing angle of the incident particle). Based on the calculations, the next silicon (Si) atom that is to collide with the incident particle is sought out in the same way as described above.

As described just above, the Monte Carlo method is a method of performing a simulation about a state that incident particles implanted into a substrate repeatedly collide with atoms contained in the substrate. The method is a method of tracing a single incident particle that is any one of the incident particles up to a time when the incident particle collides repeatedly and finally the particle releases energy to turn stationary.

In the Monte Carlo method, incident particles are simulated as described above one by one in a repeated and sequential manner. Finally, about each of the entire incident particles, the position coordinates of the position where the incident particle stands stationary (the stationary position coordinates) are calculated. In this way, data can be obtained on the distribution of the incident particles in the substrate.

In the meantime, there is caused a case where an incident particle collides with an atom contained in a substrate (substrate atom), whereby the substrate atom obtains a sufficient kinetic energy. In such a case, the substrate atom, which has obtained the sufficient energy, may jump (recoil) from the position where this substrate atom is originally located. According to the Monte Carlo method, in the same way as the incident particles, the substrate atom, which is called the recoiled atom, can also be traced up to a time when the recoiled atom turns stationary. In other words, the Monte Carlo method is a simulating method, which is copes with a case where the structure of the substrate is complicated, a case where the material thereof is uneven, or some other case also. Therefore, the Monte Carlo method makes it possible to give precise results adapted for an actual physical phenomenon.

However, in a case as described above, the number of collisions of incident particles and substrate atoms that are attempted in a simulating method is enormous. Therefore, a calculating-time necessary for the simulation increases largely.

Furthermore, the number of recoiled atoms having position coordinates changed by the collisions is also enormous. Therefore, data on the position coordinates of individual atoms necessary for performing such a simulating method also increase numerously. When the data on the position coordinates of the individual atoms are calculated and stored by a computer, resources of the computer are largely consumed.

Therefore, in order to restrain the consumption of the calculating-time necessary for the simulating method, and the computer resources, a simulation has been made by the Monte Carlo method without considering data on the position coordinates of the recoiled atoms, which are shifted from the originally arranged positions thereof based on collision with the incident particles, that is, data on a change in the ratio by number between (entire) constituting atom species in the substrate. It has been generally considered that such a Monte-Carlo-method-used simulation makes it possible to reproduce an actual physical phenomenon.

However, about the step of implanting many incident particles into a substrate so that the incident particles cause a large change in the composition of atoms constituting the substrate, an actual physical phenomenon cannot be faithfully reproduced in the case of making a Monte-Carlo-method-used simulation without considering data on a change in the composition of the atoms in the substrate (i.e., the ratio by number between the constituting atom species therein). Furthermore, in order to reproduce faithfully a physical phenomenon caused in a case as described above, i.e., a case where the ratio by number between the constituting atom species in a substrate (the composition of the atoms in the substrate) is largely varied by incident particles, it is necessary, at the time of searching out an atom which is to be a partner in collision with any one of the incident particles, to consider a change in the ratio by number between the constituting atom species in the substrate, this change being caused by previously-implanted ones of the incident particles.

Thus, the inventors have deliberated a method about which even when the ratio by number between the constituting atom species in a substrate is varied by incident particles, a simulation using the Monte Carlo method is performed while the consumption of calculating-time and computer resources is restrained, whereby an actual physical phenomenon is faithfully reproduced. In other words, the inventors have gained an idea of performing a simulation, considering a change in the composition of atoms in a substrate without using stationary position coordinates of the individual atoms. Specifically, the inventors have gained the following idea: whenever a simulation ends about one incident particle, one cell is selected from a plurality of cells formed by dividing the substrate based on results of the simulation; the ratio by number between constituting atom species contained in the selected cell is calculated based on the simulation result; thereafter, a simulation about another incident particle is performed; and at the time of the simulation, the calculated ratio by number between the constituting atom species is used to search out an atom which is to a partner in collision with a single incident particle which is to be afterward implanted.

Therefore, the embodiments of the present invention make the following possible even when the ratio by number between the constituting atom species in a substrate is changed by incident particles: while an effect that the change produces is received, an actual physical phenomenon is precisely realized and simultaneously the consumption of calculating-time and computer resources is restrained.

### First Embodiment

A description is made herein about a first embodiment of the invention that is a simulating method for simulating the step of implanting oxygen ions into a silicon substrate in order to produce an SOI (Silicon on Insulator) substrate according to the SIMOX (Separation by Implanted Oxygen) process.

The SIMOX process is specifically a method of implanting oxygen ions into a silicon substrate in order to produce an SOI substrate, thereby burying the ions deeply into the silicon substrate to form an oxide film. In this process, the implanted oxygen ions remain in the silicon substrate, and further collide with oxygen ions implanted afterward into the substrate. In other words, in this process, the implanted oxygen ions cause a change in the composition of atoms constituting the silicon substrate. Therefore, this simulating method is used to gain the distribution of oxygen ions in a silicon substrate.

This simulating method is described herein; however, the present invention is not limited thereto.

As illustrated in FIG. 1, a semiconductor process simulating device 1 for performing the simulating method is a tool having a function of performing a simulation by making a numerical calculation, through a computer, about individual steps for the production of a semiconductor, such as an oxidizing step, a depositing step, a patterning step, an etching step, an ion implanting step, an annealing step, and a silicide forming step. The device 1 may handle steps other than the steps shown in FIG. 1, for example, a washing step and an epitaxial growing step. This semiconductor process simulating device 1 has a function of reading out data used to make calculations about these steps, a function of outputting results of the calculations, a function of setting parameters necessary for the calculations, a function of setting cells (control volumes) for solving model expressions about physical phenomena, a function of memorizing the calculated data, and/or some other function.

The simulating method described herein is a method performed by use of a section having the ion-implanting-step-simulating function in the semiconductor process simulating device 1 illustrated in FIG. 1.

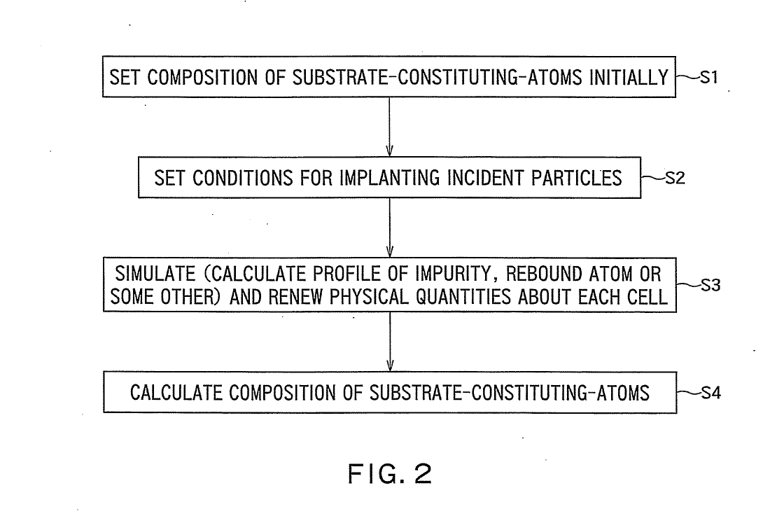

The process simulating method of the present embodiment for simulating an ion implanting step is performed in accordance with a flowchart as shown in FIG. 2, whereby the distribution of oxygen ions in a silicon substrate can be obtained.

Step 1: the step of setting the composition of atoms constituting the substrate initially;

Step 2: the step of setting conditions for implanting incident particles into the substrate;

Step 3: the step of performing simulations and renewing physical quantities about individual cells; and

Step 4: the step of calculating the composition of the atoms constituting the substrate.

Specifically, each of these steps is composed of substeps described below.

### Step 1:

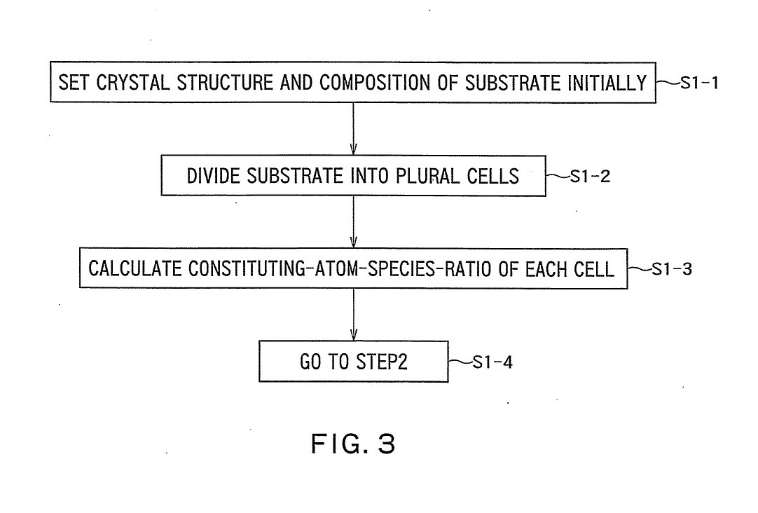

With reference to a flowchart of FIG. 3, a description is made about details of the step 1 of “setting the composition of atoms constituting the substrate initially”. A decision is first made about the crystal structure and the composition of the silicon substrate, into which oxygen ions are to be implanted (substep S1-1). The silicon substrate is divided (comparted) into cells which each have an appropriate size and have the same volume (substep S1-2). The ratio by number between the atom species which constitute each of the cells (control volumes), i.e., the composition of the atoms is calculated based on the crystal structure and the others of the silicon substrate, which are beforehand decided, and then recorded. More specifically, a point (nodal point in a discretized lattice) corresponding to each of the cells (control volumes) is beforehand specified, and the calculated value is recorded in the corresponding point. In the following description, any value calculated about each of the cells is recorded in a point (nodal point in the discretized lattice) corresponding to the cell (substep S1-3). The process of the present embodiment is then advanced to the step 2 (substep S1-4).

The description herein has been made under the conditions that the silicon substrate is divided into cells having the same volume. However, usable cells are not limited to cells having the same volume; thus, the substrate may be divided into cells having volumes different from each other dependently on their locations of the silicon substrate. The shape of the cells is not limited to a cube or a rectangular parallelepiped.

### Step 2:

In the step 2 of “setting conditions for implanting incident particles into the substrate”, conditions for implanting oxygen ions into the substrate are inputted. For example, the following are inputted: the energy quantity of the implanted oxygen ions; a relative positional relationship (incident angle) between the beam of the ions and the silicon substrate; and the number of the implanted oxygen ions. Next, the present process is advanced to the step 3.

### Step 3:

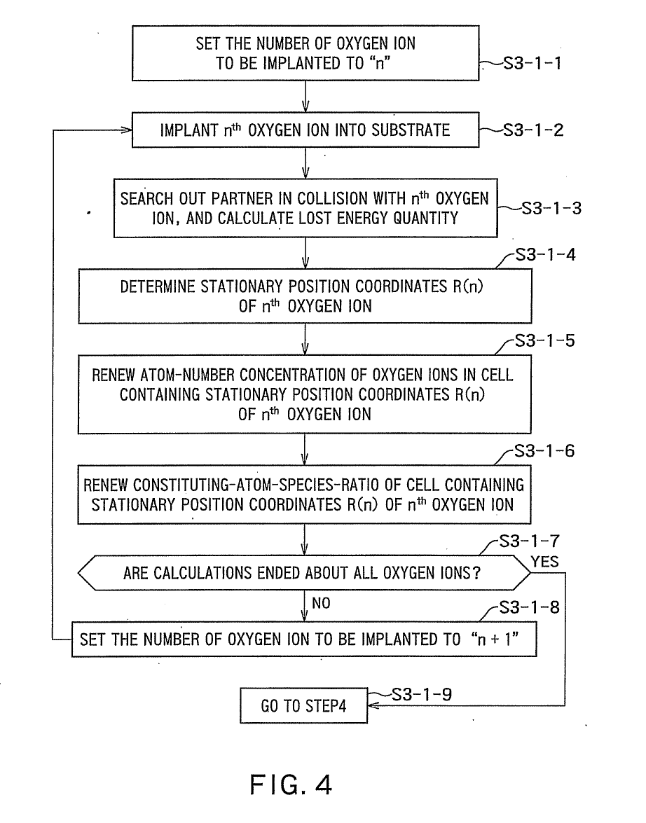

With reference to a flowchart of FIG. 4, a description is made about details of the step 3 of “performing simulations and renewing physical quantities about individual cells”.

A simulation is first performed about first one of the oxygen ions, the number of which has been inputted in the step 2.

The number of the oxygen ion is set to “first” (n=1) (substep S3-1-1).

In accordance with the ion-implanting conditions set in the step 2, the first single oxygen ion is implanted into the substrate. A position in which the first oxygen ion is implanted, and others may be decided by use of random numbers (substep S3-1-2).

Based on the ratio by number between the atom species constituting each of the cells, this ratio having been calculated in the substep S1-3, a silicon atom, which is to be a partner in collision with the first oxygen ion, is sought out. Specifically, while the first oxygen ion, which is traveling in the substrate while undergoing collision with one of the silicon atoms constituting the substrate repeatedly, is traced, the kinetic energy lost from the first oxygen ion by the collision is calculated (substep S3-1-3).

Based on the calculation, stationary position coordinates (R1) of the first oxygen ion, where the ion stands stationary, are calculated (substep S3-1-4).

The wording “the ion stands (or turns) stationary” means not only a case where the kinetic energy of the ion turns zero but also any case where the ion has a smaller kinetic energy than the kinetic energy value permitting the ion to be regarded as standing still.

A cell containing the stationary position coordinates (R1) of the first oxygen ion (stationary cell) is determined from the entire cells. The atom-number concentration (atom-number density) of oxygen ions contained in this cell is calculated and recorded. Specifically, the first single implanted oxygen ion is newly added to the determined cell, whereby the atoms contained in this cell are different from the atoms in the cell before the first oxygen ion is implanted into the cell; thus, the atom-number concentration of the oxygen ions contained in this cell is calculated, and then recorded (substep S3-1-5).

Furthermore, based on the atom-number concentration of the oxygen ions, the ratio by number between the constituting atom species contained in this cell (the composition of the atoms in the cell) is calculated, and the resultant value is recorded (substep S3-1-6).

Next, in the same way as in the case of the first oxygen ion, a simulation is performed about a second single oxygen ion of the implanted oxygen ions (substep S3-1-7).

In the same way as in the case of the first oxygen ion, the number of the oxygen ion is set to “second” (n=2) (substep S3-1-8).

In accordance with the ion-implanting conditions set in the step 2, the second oxygen ion is implanted into the substrate. A position in which the second oxygen ion is implanted, and others may be decided by use of random numbers (substep S3-1-2).

Using the ratio by number between the constituting atom species that has been calculated in the previous substep S3-1-6, a silicon atom or oxygen ion, which is to collide with the second oxygen ion, is sought out from the entire atoms in the substrate. While the second oxygen ion, which is traveling in the substrate while undergoing repeated collision, is traced, the kinetic energy lost from the second oxygen ion by the collision is calculated (substep S3-1-3).

Based on the calculation, stationary position coordinates (R2) of the second oxygen ion, where the ion stands stationary, is calculated (substep S3-1-4).

The atom-number concentration is calculated in the cell in which the stationary position coordinates (R2) of the second oxygen ion are contained, and then recorded (substep S3-1-5).

Based on the atom-number concentration calculated in the substep S3-1-5, the ratio by number between the constituting atom species contained in this cell is calculated, and then recorded (substep S3-1-6).

A third oxygen ion, a fourth oxygen ion, . . . an n^{th} oxygen ion of the incident ions, the number of which is the desired value, are simulated one by one by use of the above-mentioned Monte Carlo method (substep S3-1-1 to substep S3-1-8).

After the above-mentioned simulations of all the incident oxygen ions are ended, the present process is advanced to the step 4 (substep S3-1-9).

### Step 4:

Using the respective constituting-atom-species ratios by number in the individual cells, these ratios having been obtained in the step 3, the distribution of the oxygen ions contained in the silicon substrate is calculated.

Therefore, the present embodiment makes it possible that while the ratio by number between the atom species constituting a silicon substrate, which is varied by incident oxygen ions implanted thereinto, is feed-backed, an oxygen ion that is to be next implanted into the substrate is simulated without using the stationary position coordinates of individual oxygen ions implanted thereinto. Therefore, while the consumption of calculating-time and computer resources is restrained, a highly precise simulation result can be obtained.

In the present embodiment, in which after a single incident particle (oxygen ion) turns stationary, the ratio by number between the atom species constituting the concerned cell is calculated. While on the other hand, in an example of a variation of the present embodiment, in which after a plurality of incident particles turn stationary, the ratio by number between the atom species constituting each of the concerned cells may be calculated and then recorded. According to this example, an increase in calculating-time can be restrained.

### Second Embodiment

Herein, a description is made about a second embodiment, which is a method for simulating the step of implanting As ions into a silicon substrate in order to form a source/drain diffusion layer of a MOSFET structure in the silicon substrate.

Specifically, in the step, a gate insulating film containing Hf atoms is formed on the silicon substrate. The implantation of the As ions into the silicon substrate causes the As ions to collide with the Hf atoms contained in the gate insulating film so that the collision-undergoing Hf atoms may be jumped (recoiled) so as to enter the silicon substrate. In other words, in the step, the implanted As ions cause a change in the composition of the atoms constituting the silicon substrate. Therefore, the simulating method of the present embodiment is used to gain a final distribution of the Hf atoms in the silicon substrate.

The invention is not limited to the simulation method described herein.

The present embodiment is different from the first embodiment in that not only implanted incident particles but also recoiled atoms jumped (recoiled) by collision with the incident particles are traced. This manner makes it possible to realize an actual physical phenomenon with a high precision.

The process simulating method of the present embodiment for simulating an ion implanting step is a method performed by use of the section having the ion-implanting-step-simulating function in the semiconductor process simulating device 1, which has been illustrated in FIG. 1. This simulating device 1 has been described in the first embodiment; thus, detailed description thereof will not be repeated here.

In the same manner as in the first embodiment, the process simulating method of the present embodiment for simulating an ion implanting step is performed in accordance with a flowchart as shown in FIG. 2, whereby the distribution of Hf atoms in a silicon substrate can be obtained.

Step 1: the step of setting the composition of atoms constituting the substrate initially;

Step 2: the step of setting conditions for implanting incident particles into the substrate;

Step 3: the step of performing simulations and renewing physical quantities about individual cells; and

Step 4: the step of calculating the composition of the atoms constituting the substrate.

In this embodiment, the steps 1, 2 and 4 are the same as in the first embodiment; thus, detailed description thereof will not be repeated here. A description is made only about the step 3, which is different from that in the first embodiment.

### Step 3:

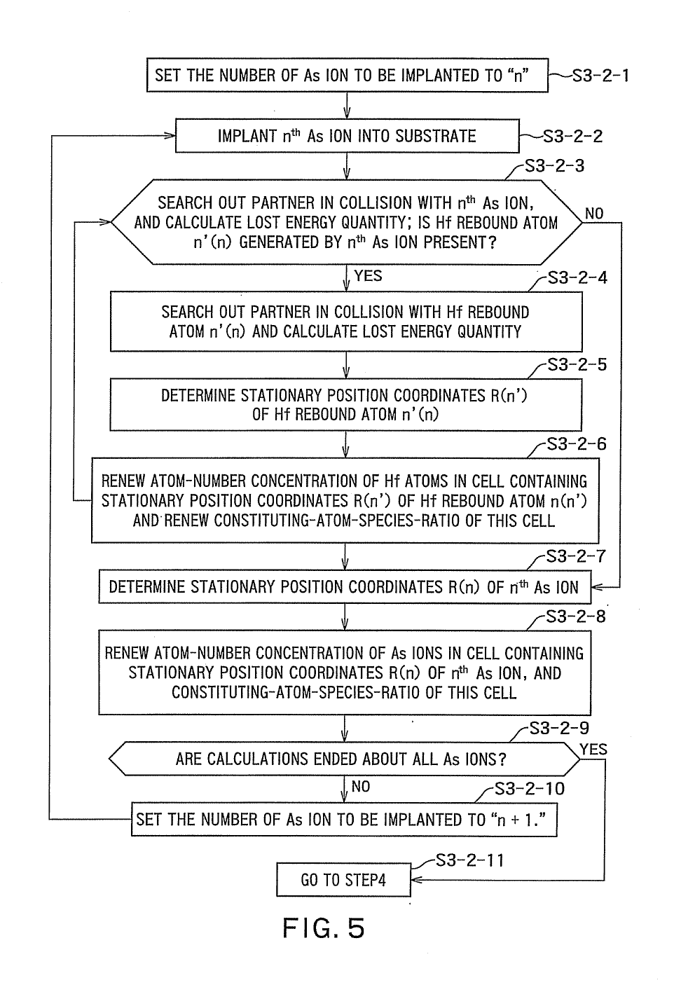

With reference to a flowchart of FIG. 5, a description is made about details of the step 3 of “performing simulations and renewing physical quantities about individual cells”.

A simulation is first performed about first one of the As ions, the number of which has been inputted in the step 2.

The number of the As ion is set to “first” (n=1) (substep S3-2-1).

In accordance with the ion-implanting conditions set in the step 2, the first single As ion is implanted into the substrate in the same way as in the first embodiment. A position in which the first As ion is implanted, and others may be decided by use of random numbers (substep S3-2-2).

Based on the ratio by number between the atom species (silicon atoms, oxygen atoms, and Hf atoms) constituting each of the cells, this ratio having been calculated in the substep S1-3, an atom that is to be a partner in collision with the first As ion is sought out. Specifically, while the first As ion, which is traveling in the substrate while undergoing collision with one of the silicon atoms constituting the substrate repeatedly, is traced, the kinetic energy lost from the first As ion by the collision is calculated (substep S3-2-3).

In a case where at the time of tracing the first As ion an Hf atom that collides with the first As ion so as to recoil is present out of the entire Hf atoms, the tracing of the first As ion is once stopped when the recoiled Hf atom turns out to be present. The single recoiled Hf atom is then simulated. Specifically, also about the first recoiled Hf atom (1′ (1)), an atom which is to be a partner in collision therewith is sought out based on the constituting-atom-species-ratio by number of each of the cells, which has been calculated in the substep S1-3. Specifically, while the first recoiled Hf atom, which is traveling while undergoing collision with one of the atoms contained in the substrate repeatedly, is traced, the kinetic energy lost from the first recoiled Hf atom (1′ (1)) by the collision is calculated (substep S3-2-4).

Based on the calculation, stationary position coordinates (R1′ (1)) where the first recoiled Hf atom (1′ (1)) turns stationary are calculated (substep S3-2-5).

The wording “the recoiled Hf atom turns stationary” means not only a case where the kinetic energy of the recoiled Hf atom turns zero but also any case where the recoiled Hf atom has a smaller kinetic energy than the kinetic energy value permitting the atom to be regarded as standing still. The same matter is applied to any recoiled Hf atom in subsequently performed steps, as well as any As ion therein.

A cell containing the stationary position coordinates (R′ (1)) of the first recoiled Hf atom (1′ (1)) (recoiled atom stationary cell) is determined from the entire cells. The atom-number concentration (atom-number density) of Hf atoms contained in this determined cell is calculated and recorded. Furthermore, based on the calculated atom-number concentration of the Hf atoms, the ratio by number between the constituting atom species contained in this cell is calculated, and recorded (substep S3-2-6).

Next, the tracing of the first As ion, which has once been stopped, is again started, and subsequently based on the constituting-atom-species-ratio by number calculated in the substep S3-2-6, an atom that is to be a partner in collision with the first As ion is again sought out (substep S3-2-3).

In the same manner as described above, in a case where a second recoiled Hf atom (1′ (2))) that collides with the first As ion so as to recoil is present out of the entire Hf atoms, the tracing of the first As ion is again stopped when the second recoiled Hf atom (1′ (2)) turns out to be present. The second recoiled Hf atom (1′ (2)) is then simulated. Specifically, in the same manner as in the simulation of the first recoiled Hf atom, an atom that is to be a partner in collision with the second recoiled Hf atom is sought out of the entire atoms contained in the substrate based on the constituting-atom-species-ratio by number calculated in the substep S3-2-6. The second recoiled Hf atom (1′ (2)), which is traveling while undergoing collision repeatedly, is then traced. The kinetic energy lost from the second recoiled Hf atom (1′ (2)) by the collision is calculated (substep S3-2-4).

Based on the calculation, stationary position coordinates (R1′ (2)) where the second recoiled Hf atom (1′ (2)) turns stationary is calculated (substep S3-2-5).

A cell containing the stationary position coordinates (R′1 (2)) of the second recoiled Hf atom is determined from the entire cells. The atom-number concentration of Hf atoms contained in this cell is calculated and recorded. Furthermore, based on the calculated atom-number concentration of the Hf atoms, the ratio by number between the constituting atom species contained in this cell is calculated, and recorded (substep S3-2-6).

Up to the time when the first As ion turns stationary, a third recoiled Hf atom, a fourth recoiled Hf atom, . . . an n^{th} recoiled Hf atom (1′ (n)), that is, all recoiled Hf atoms recoiled by the first As ion are subjected one by one to the same calculation of recoiled-Hf-atom stationary position coordinates and renewing of the constituting-atom-species-ratio as described above (substep S3-2-3 to substep S3-2-6).

In the same way as in the first embodiment, while the first As ion, which is traveling in the substrate while undergoing collision with one of the atoms contained in the substrate repeatedly, is traced, the kinetic energy lost from the first As ion by the collision is calculated. Based on the calculation, stationary position coordinates (R1) where the first As ion turns stationary are calculated (substep S3-2-7).

A cell containing the stationary position coordinates (R1) where the first As ion turns stationary (stationary cell) is determined from the entire cells. The atom-number concentration of As ions contained in this determined cell is calculated and recorded. Furthermore, based on the calculated atom-number concentration of the As ions, the ratio by number between the constituting atom species contained in this cell is calculated, and recorded (substep S3-2-8).

Next, in the same way as in the case of the first As ion, a simulation is performed about a second single As ion of the implanted As ions (substep S3-2-9).

In the same way as in the case of the first As ion, the number of the As ion is set to “second” (n=2) (substep S3-2-10).

In accordance with the ion-implanting conditions set in the step 2, the second As ion is implanted into the substrate. A position in which the second As ion is implanted, and others may be decided by use of random numbers (substep S3-2-2).

Based on the constituting-atom-species-ratio by number calculated in the previous substep S3-2-8, an atom that is to collide with the second As ion is sought out from the entire atoms contained in the substrate (substep S3-2-3).

In the same manner as in the case of the first As ion, a simulation is performed also about any recoiled Hf atom (2′ (n)) that collides with the second As ion so as to recoil, so that the constituting-atom-species-ratio by number is calculated (substep S3-2-4 to substep S3-2-6). At this time, all recoiled Hf atoms (2′ (n)) recoiled by the second As ion are simulated one by one.

In the same manner as in the case of the first As ion, while the second As ion, which is traveling in the substrate while undergoing collision with one of the atoms contained in the substrate repeatedly, is traced, the kinetic energy lost from the second As ion by the collision is calculated. Based on the calculation, stationary position coordinates (R2) where the second As ion turns stationary are calculated (substep S3-2-7).

A cell containing the stationary position coordinates (R2) where the second As ion turns stationary is determined from the entire cells. The atom-number concentration of As ions contained in this determined cell is calculated and recorded. Furthermore, based on the calculated atom-number concentration of the As ions, the ratio by number between the constituting atom species contained in this cell is calculated, and recorded (substep S3-2-8).

A third As ion, a fourth As ion, . . . an n^{th} As ion out of the entire incident ions, the number of which is the desired value, are simulated one by one by use of the above-mentioned Monte Carlo method (substep S3-2-2 to substep S3-2-10).

After the above-mentioned simulations of the entire incident As ions are ended, the present process is advanced to the step 4 (substep S3-2-11).

As described above, according to the present embodiment, in a case where in the step of implanting As ions into a silicon substrate having a gate insulating film containing Hf atoms a final distribution state of the Hf atoms in the silicon substrate is gained, a highly precise simulating process can be attained, considering the following: the composition of the substrate that is changing with the progress of the implantation of the As ions into the substrate; and such a possibility that a Hf atom introduced into the silicon substrate from the gate insulating film by collision with one of the As ions is further struck into the depth of the silicon substrate by subsequently implanted one of the As ions, or by the other Hf atoms. Furthermore, the consumption of calculating-time and computer resources can be restrained.

The first and second embodiments have been described under the condition that the number of the implanted incident particles (oxygen ions or As ions) is equal to that of incident particles implanted in an actually performed ion implantation. However, in order to restrain the consumption of calculating-time and computer resources, the number of the incident particles in these embodiments may be larger or smaller than the number of incident particles in an actually performed ion implantation. In such a case, in order to match simulation results with the number of incident particles in an actual ion implantation, the simulation results may be normalized.

The first and second embodiments have been described under the condition that incident particles are implanted into a silicon substrate; however, the substrate into which incident particles are to be implanted is not limited to any silicon substrate, and may be a substrate having a complicated structure made of a plurality of materials as far as the substrate is a target into which incident particles can be implanted.

A program for realizing at least one part of the ion implantation simulation of each of the above-mentioned embodiments may be stored into a recording medium such as a flexible disk or a CD-ROM, and caused to be read by a computer and to be performed thereby. The recording medium is not limited to any medium that can be set into a computer and taken out therefrom, such as a magnetic disk or optical disk, and may be a fixed-type recording medium, such as a hard disk device or a memory.

The program for realizing at least one part of the ion implantation simulation of each of the above-mentioned embodiments may be distributed through the Internet, or any other communication network, which may be a wireless communication network. In the state that the program is coded, modulated, or compressed, the program may be distributed through any wired communication network, such as the Internet, or any wireless communication network, or in the form that the program is stored in a recording medium.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. An ion implanting simulating method of implanting incident particles into a substrate, and gaining stationary position coordinates of each of the incident particles in the substrate, thereby calculating the distribution of the incident particles in the substrate,
the method comprising repeating the followings desired times by a computer:
implanting one of the incident particles into the substrate;
calculating the trace of the incident particle traveling in the substrate while undergoing collision with an atom contained in the substrate repeatedly, and the energy lost from the incident particle by the collision, based on a beforehand-inputted composition of the substrate, thereby calculating stationary position coordinates of the incident particle; and
renewing the composition of the substrate in accordance with a matter that the substrate contains the implanted incident particle.

2. The ion implanting simulating method of claim 1, wherein the renewing the composition of the substrate comprises:
forming a plurality of cells by comparting the substrate;
determining one cell containing the stationary position coordinates of the implanted incident particle from the plurality of cells; and
calculating the composition of the substrate under the condition that the cell contains the implanted incident particle.

3. The ion implanting simulating method of claim 2, wherein the plurality of cells have the same volume.

4. The ion implanting simulating method of claim 2, wherein the plurality of cells have volumes different from each other.

5. The ion implanting simulating method of claim 1, wherein the stationary position coordinates of the incident particle are coordinates of the position of the incident particle when the kinetic energy of the incident particle turns zero.

6. The ion implanting simulating method of claim 1, wherein the stationary position coordinates of the incident particle are coordinates of the position of the incident particle when the kinetic energy of the incident particle turns into a desired value or less.

7. The ion implanting simulating method of claim 1, wherein the substrate is a silicon substrate, and the incident particles are oxygen ions.

8. An ion implanting simulating method of implanting incident particles into a substrate, and calculating the composition of the substrate that has been changed by the implantation of the incident particles into the substrate,
the method comprising repeating the followings desired times by a computer:
implanting one of the incident particles into the substrate;
calculating the trace of the incident particle traveling in the substrate while undergoing collision with an atom contained in the substrate repeatedly, and the energy lost from the incident particle by the collision, based on a beforehand-inputted composition of the substrate, thereby calculating stationary position coordinates of the incident particle;
when the atom in the substrate is recoiled by the collision with the incident particle,
defining the atom recoiled by the collision as a recoiled atom,
calculating the trace of the recoiled atom traveling in the substrate while undergoing collision with another atom contained in the substrate repeatedly, and the energy lost from the recoiled particle by the collision, based on the beforehand-inputted composition of the substrate, thereby calculating stationary position coordinates of the recoiled particle;
forming a plurality of cells by comparting the substrate;
determining first cell containing the stationary position coordinates of the implanted incident particle and second cell containing the stationary position coordinates of the recoiled atom from the plurality of cells; and
calculating the composition of the substrate under the condition that the first cell contains the implanted incident particle and the second cell contains the recoiled atom, thereby renewing the composition of the substrate.

9. The ion implanting simulating method of claim 8, wherein the plurality of cells have the same volume.

10. The ion implanting simulating method of claim 8, wherein the plurality of cells have volumes different from each other.

11. The ion implanting simulating method of claim 8, wherein the stationary position coordinates of the incident particle are coordinates of the position of the incident particle when the kinetic energy of the incident particle turns zero.

12. The ion implanting simulating method of claim 8, wherein the stationary position coordinates of the incident particle are coordinates of the position of the incident particle when the kinetic energy of the incident particle turns into a desired value or less.

13. The ion implanting simulating method of claim 8, wherein the substrate is a silicon substrate containing Hf, and the incident particles are As ions.

14. A non-transitory computer readable medium comprising instructions that cause a computer to repeat the followings desired times:
implanting one of the incident particles into the substrate;
calculating the trace of the incident particle traveling in the substrate while undergoing collision with an atom contained in the substrate repeatedly and the energy lost from the incident particle by the collision, based on a beforehand-inputted composition of the substrate, thereby calculating stationary position coordinates of the incident particle; and
renewing the composition of the substrate in accordance with a matter that the substrate contains the implanted incident particle.

15. The computer-readable medium of claim 14, wherein the renewing the composition of the substrate comprises:
forming a plurality of cells by comparting the substrate;
determining one cell containing the stationary position coordinates of the implanted incident particle from the plurality of cells; and
calculating the composition of the substrate under the condition that the cell contains the implanted incident particle.

16. The computer-readable medium of claim 14, when the atom in the substrate is recoiled by the collision with the incident particle, further comprising:
defining the atom recoiled by the collision as a recoiled atom; and
calculating the trace of the recoiled atom traveling in the substrate while undergoing collision with another atom contained in the substrate repeatedly, and the energy lost from the recoiled particle by the collision, based on the beforehand-inputted composition of the substrate, thereby calculating stationary position coordinates of the recoiled particle.

17. The computer-readable medium of claim 16, wherein the renewing the composition of the substrate comprises:
forming a plurality of cells by comparting the substrate;
determining first cell containing the stationary position coordinates of the implanted incident particle and second cell containing the stationary position coordinates of the recoiled atom from the plurality of cells; and
calculating the composition of the substrate under the condition that the first cell contains the implanted incident particle and the second cell contains the recoiled atom, thereby renewing the composition of the substrate.
